(19) United States
(12) Patent Application Publication
(10) Pub. No.: US 2018/0214252 A1
(43) Pub. Date: Aug. 2, 2018

(54) TEETH-STRAIGHTENING WIRE, DENTAL BRACES HAVING SAME, AND TEETH-STRAIGHTENING METHOD THEREFOR

(71) Applicant: E- WIRELIGNER CO., LTD., Seoul (KR)

(72) Inventor: Youn Sic CHUN, Seoul (KR)

(21) Appl. No.: 15/558,731

(22) PCT Filed: Mar. 16, 2016
(86) PCT No.: PCT/KR2016/002641

§ 371 Date: Dec. 11, 2017

(30) Foreign Application Priority Data
Mar. 16, 2015 (KR) 10-2015-0035958
Apr. 2, 2015 (KR) 10-2015-0046720
May 21, 2015 (KR) 10-2015-0071001

(51) Int. Cl. A61C 7/20

(52) U.S. Cl. CPC A61C 7/20

(57) ABSTRACT

Dental braces according to one embodiment of the present invention comprise: wires for straightening teeth; a coating agent coated on the outer surfaces of the wires; and fixing parts for fixing the wires, coated with the coating agent, on the surfaces of the teeth and fixing the wires such that the wires can move along the longitudinal direction of the wire, wherein the coating agent coated on the wires is removed from the wires after the coating agent is covered with the fixing part, such that a clearance gap can be formed between the fixing part and the wire, thereby enabling accurate and smooth teeth-straightening.

### TECHNICAL FIELD

At least one example embodiment relates to a wire for orthodontic treatment, an orthodontic device including the wire, and an orthodontic method thereof. More particularly, at least one example embodiment relates to a wire for orthodontic treatment that may achieve a movement of a wire relative to a fixer by fixing the wire coated with a coating agent on a surface of teeth using the fixer and by removing the coating agent, thereby enabling an accurate orthodontic treatment, an orthodontic device including the wire, and an orthodontic method thereof.

### RELATED ART

In general, a non-uniform dental alignment state or a non-uniform malocclusion of teeth may cause developmental abnormalities of the teeth, developmental disorders of the jawbone, and the like. People with irregular dental alignment or malocclusion may cover their mouth with a hand when having a conversation or laughing with others, and also may be passive in interpersonal relationships, which may lead to making it difficult to have a decent social life.

In addition, when eating food, the food may not be uniformly crushed and may be stuck between teeth, which may result in various types of dental diseases or digestive system diseases.

To outperform the above issues, disclosed is an orthodontic technique for applying a constant force to teeth, modifying an alveolar bone that surrounds the teeth, and causing a movement of teeth.

For example, as disclosed in Korean Patent Application No. 10-2013-0064601, a conventional orthodontic device to which the orthodontic technique is applied may include a plurality of orthodontic brackets individually attached to the front of the respective teeth and a wire configured to connect and fix the orthodontic brackets.

Further describing, an insertion hole through which the wire is inserted is formed on each orthodontic bracket. Thus, once the orthodontic brackets are attached to the front of teeth, the wire may couple with the orthodontic brackets in the oral cavity.

However, in the conventional orthodontic device, since the bracket is attached and the wire is fixed, a mounting process may be complex and pain may arise during the mounting process. In addition, since the bracket is generally formed using a metal material, a user may have a feeling of irritation. In addition, interference may occur between an inner portion of the tongue or lips and a corner portion of the bracket, which may cause injury.

Meanwhile, a technique for forming a bracket in a tube shape similar to a shape of a needle and inserting a wire into a slot of the bracket has been studied and commercialized. However, it is not easy to manufacture a tube-shaped bracket having a very thin slot.

The conventional orthodontic device is provided in a structure in which the bracket is provided and the wire is fixed. Thus, the mounting process may be complex and pain may arise during the mounting process.

Accordingly, there is a need to develop an orthodontic device without using a bracket. However, if the bracket is not provided, it may be difficult to position a wire. Accordingly, the development of a device for accurately positioning the wire is required.

### DESCRIPTION

### Objects

At least one example embodiment provides a wire for orthodontic treatment that may achieve a movement of a wire relative to a fixer by fixing the wire coated with a coating agent on a surface of teeth using the fixer and by removing the coating agent, thereby enabling an accurate orthodontic treatment, an orthodontic device including the wire, and an orthodontic method thereof.

At least one example embodiment also provides a wire for orthodontic treatment that enables a user to barely feel a feeling of irritation and may also prevent injury from occurring in the tongue or the oral cavity since a diameter of a wire is small enough for the user to barely feel with the tongue and the fixer is provided in a round shape, an orthodontic device including the wire, and an orthodontic method thereof.

At least one example embodiment also provides a wire for orthodontic treatment that enables both the entire orthodontic treatment and partial orthodontic treatment of teeth, may be provided on the rear surface of teeth as well as the front surface of the teeth, thereby enhancing the readability of mounting and an aesthetic sense, an orthodontic device including the wire, and an orthodontic method thereof.

At least one example embodiment also provides a wire for orthodontic treatment that may form a clearance gap between a wire and a fixer by fixing the wire that includes a detachable clearance gap former on the surface of teeth using the fixer, such as resin, and by removing the clearance gap former through a simple process, thereby achieving a movement of the wire relative to resin and enabling accurate and smooth orthodontic treatment, an orthodontic device including the wire, and an orthodontic method thereof.

At least one example embodiment also provides a wire for orthodontic treatment that may easily form a clearance gap since a clearance gap former is provided in a simply separable vinyl sheath type and may further efficiently perform an orthodontic process without performing an additional operation such as a cleaning operation, an orthodontic device including the wire, and an orthodontic method thereof.

At least one example embodiment also provides a wire positioning unit that may enhance the reliability of orthodontic treatment by accurately positioning a position of a wire using a wire positioning unit before fixing the wire using a fixer, an orthodontic device including the wire positioning unit, and an orthodontic method thereof.

### Solution

According to an aspect of at least one example embodiment, there is provided an orthodontic device comprising a wire for orthodontic treatment of teeth; a coating agent configured to coat an outer surface of the wire; and a fixer configured to fix the wire coated with the coating agent on a surface of the teeth, and to fix the wire to be movable along a lengthwise direction of the wire. The coating agent that coats the wire is covered with the fixer and then removed from the wire and a clearance gap is formed between the fixer and the wire. Through this configuration, the orthodontic treatment may be accurately and smoothly performed.

The coating agent may use a material that melts in an intraoral temperature, a material that melts in reaction with the intraoral saliva, or a water-soluble.

A mobility of the wire relative to the fixer may be adjusted by adjusting a size of a width or a diameter of the wire or by adjusting a coating thickness of the coating agent relative to the wire.

The wire may be manufactured as a shape memory alloy to store a shape of the wire based on a shape of teeth corresponding to an orthodontic target.

A diameter of the wire may be within 0.007 to 0.022 inches, or the wire may have a square cross-section or a rectangular cross-section of which a diagonal length is within 0.007 to 0.022 inches.

The fixer may be provided using resin having flowability and hardened on the surface of the teeth.

According to an aspect of at least one example embodiment, there is provided a wire for orthodontic treatment of teeth, comprising a coating agent configured to coat an outer surface of the wire for orthodontic treatment. The coating agent that coats the wire is fixed by a fixer configured to fix the wire on a surface of the teeth and removed from the wire and a clearance gap is formed between the fixer and the wire. Accordingly, the wire may be movable relative to the fixer.

The coating agent may use a material that melts in an intraoral temperature, a material that melts in reaction with the intraoral saliva, or a water-soluble.

According to an aspect of at least one example embodiment, there is provided an orthodontic method of the orthodontic device, the method comprising positioning the wire coated with the coating agent on the surface of the teeth; fixing the wire coated with the coating agent on the surface of the teeth using the fixer having flowability; and forming a clearance gap between the wire and the fixer by removing the coating agent from the wire. The clearance gap enables the wire to be movable relative to the fixer, thereby enabling an orthodontic treatment of the teeth.

The orthodontic method may further include spraying a cleaning solution over the fixer and cleaning the fixer after fixing the wire on the surface of the teeth.

The coating agent may use a material that melts in an intraoral temperature, a material that melts in reaction with the intraoral saliva, or a water-soluble.

A mobility of the wire relative to the fixer may be adjusted by adjusting a size of a width or a diameter of the wire or by adjusting a coating thickness of the coating agent relative to the wire, and the wire may be manufactured as a shape memory alloy to store a shape of the wire based on a shape of teeth corresponding to an orthodontic target.

According to an aspect of at least one example embodiment, there is provided an orthodontic device comprising a wire for orthodontic treatment of teeth; a clearance gap former detachably provided to the wire to surround a portion of an outer surface of the wire; and a fixer configured to fix the wire that includes the clearance gap former on a surface of the teeth, and to fix the wire to be movable along a lengthwise direction of the wire. The clearance gap former includes an inner diameter or an inner width corresponding to a diameter or a width of the wire, and one side of the clearance gap former is provided as a separable portion to surround the wire and to be separable from the wire, and when the wire that includes the clearance gap former is covered with the fixer, a clearance gap is formed between the wire and the fixer by removing the clearance gap former from the wire. Through this configuration, a movement of the wire relative to resin may be configured and the orthodontic treatment may be accurately and smoothly performed.

The clearance gap former may comprise a clearance gap forming body including the inner diameter corresponding to the diameter or the width of the wire and having a thickness corresponding to the clearance gap, and the separable portion may be a slit that is formed on one side of the clearance gap forming body along a lengthwise direction of the clearance gap forming body.

The clearance gap former may be formed using an elastic vinyl sheath.

The clearance gap former may be formed using a material that does not chemically react to the wire or the fixer.

When the wire that includes the clearance gap former is covered with the fixer, the clearance gap former may be formed so that at least one end of both ends of the clearance gap former is exposed from the fixer, and the clearance gap former may be removed from the wire by pulling a portion of the clearance gap former exposed from the fixer.

At least one end of the both ends of the clearance gap former may be provided as a member to be gripped that is gripped by a grip device.

A mobility of the wire relative to the fixer may be adjusted by adjusting a size of the diameter or the width of the wire or by adjusting a thickness of the clearance gap former that is detachably provided to the wire.

The fixer may be provided using resin having flowability and hardened on the surface of the teeth.

According to an aspect of at least one example embodiment, there is provided a wire for orthodontic treatment of teeth, comprising a wire member; and a clearance gap former detachably provided to the wire member to surround a portion of an outer surface of the wire member. The clearance gap former includes an inner diameter or an inner width corresponding to a diameter or a width of the wire member, and one side of the clearance gap former is provided as a separable portion to surround the wire member and to be separable from the wire member, and when the wire member that includes the clearance gap former is covered with a fixer configured to fix the wire member to the teeth, a clearance gap is formed between the wire member and the fixer by removing the clearance gap former from the wire member.

The clearance gap former may be formed using an elastic vinyl sheath. The clearance gap former may comprise a clearance gap forming body including the inner diameter corresponding to the diameter or the width of the wire member and having a thickness corresponding to the clearance gap, and the separable portion may be a slit that is formed on one side of the clearance gap forming body along a lengthwise direction of the clearance gap forming body.

According to an aspect of at least one example embodiment, there is provided an orthodontic method of an orthodontic device, the method comprising positioning a wire detachably coupled with a clearance gap former on the surface of teeth; fixing the wire coupled with the clearance gap former on the surface of the teeth using a fixer in a resin form; and forming a clearance gap between the wire and the fixer by separating the clearance gap former from the wire.

The clearance gap former may be formed using an elastic vinyl sheath. The clearance gap former may comprise a clearance gap forming body including an inner diameter corresponding to a diameter or a width of the wire and having a thickness corresponding to the clearance gap; and a separable portion in a slit type formed on one side of the clearance gap forming body along a lengthwise direction of the clearance gap forming body. The forming of the clearance gap may comprise separating the clearance gap former from the wire by spreading the slit of the clearance gap forming body in response to pulling one side of the clearance gap former between the wire and the fixer.

According to an aspect of at least one example embodiment, there is provided an orthodontic device comprising a wire for orthodontic treatment of teeth; a sheath configured to couple with the wire to surround a portion of an outer surface of the wire and to be movable in a lengthwise direction of the wire; and a fixer configured to fix on a surface of the teeth to cover the wire that includes the sheath. The wire is movable relative to the fixer by attaching the sheath to the fixer through a reaction between the fixer and the sheath on a contact portion.

A material for adhesion may be provided between the sheath and the fixer for mutual reaction between the fixer and the sheath on the contact portion.

The sheath may be provided using a material capable of integrating with the fixer through chemical reaction to the fixer, and no reaction may occur between the sheath and the wire and the wire may be movable relative to the sheath.

According to an aspect of at least one example embodiment, there is provided a wire positioning unit for positioning a wire for orthodontic treatment of teeth, comprising a body; a slot recessed from an inner surface of the body that faces a surface of the teeth, and configured to position the wire on the surface of the teeth; and a protrusion provided to the body so that the body is detachably hung by the teeth. A mounting hole through which a fixer configured to fix the wire on the surface of the teeth is provided to the wire is formed on at least a portion of a central portion of the body. Through this configuration, a position of the wire may be positioned accurately by the wire positioning unit before fixing the wire, thereby enhancing the reliability of orthodontic treatment.

The mounting hole of the body may be recessed inward from an opposite side of the protrusion and the body may be in a U shape.

The slot may be formed with a size corresponding to a largest wire among wires applicable to the teeth.

According to an aspect of at least one example embodiment, there is provided an orthodontic device comprising a wire for orthodontic treatment of teeth; a fixer configured to fix the wire on a surface of the teeth, and to fix the wire to be movable along a lengthwise direction of the wire; and a wire positioning unit provided to the teeth before fixing the wire on the surface of the teeth using the fixer and configured to position the wire relative to the teeth. Through this configuration, a position of the wire may be positioned accurately by the wire positioning unit before fixing the wire using the fixer, thereby enhancing the reliability of orthodontic treatment.

The wire positioning unit may comprise a body; a slot recessed from an inner surface of the body that faces the surface of the teeth and configured to position the wire on the surface of the teeth; and a protrusion provided to the body so that the body is detachably hung by the teeth. A mounting hole through which a fixer configured to fix the wire on the surface of the teeth is provided to the wire is formed on at least a portion of a central portion of the body.

The mounting hole of the body may be recessed inward from an opposite side of the protrusion and the body may be in a U shape.

A diameter of the wire may be within 0.007 to 0.022 inches, or the wire may have a square cross-section or a rectangular cross-section of which a diagonal length is within 0.007 to 0.022 inches, and the slot may be formed with a size corresponding to a largest wire among wires applicable to the teeth.

The fixer may be provided using resin having flowability and hardened on the surface of the teeth.

The orthodontic device may further include a coating agent configured to coat the outer surface of the wire. The coating agent may be covered with the fixer and then removed from the wire and a clearance gap may be formed between the fixer and the wire.

According to an aspect of at least one example embodiment, there is provided an orthodontic method of the orthodontic device, the method comprising a wire position setting operation of positioning the wire for orthodontic treatment on a casting mold that is acquired from a bone of teeth corresponding to an orthodontic target and providing the wire positioning unit manufactured to fit the casting mold to model teeth of the casting mold; a mounting operation of separating the wire positioning unit and the wire from the casting mold, positioning the wire on the teeth corresponding to the orthodontic target, and providing the wire positioning unit; and a wire fixing operation of fixing the wire on the surface of the teeth using the fixer; and a unit separating operation of separating the wire positioning unit from the wire.

The fixer used for the wire fixing operation may be provided using resin having flowability and hardened on the surface of the teeth.

In the wire fixing operation, a mounting hole that passes in a thickness direction may be formed on at least a portion of the central portion of the body to provide the fixer to the wire in a state in which the wire positioning unit is provided.

According to example embodiments, it is possible to achieve a movement of a wire relative to a fixer by fixing the wire coated with a coating agent on a surface of teeth using the fixer and by removing the coating agent, thereby enabling an accurate orthodontic treatment.

Also, according to example embodiments, a user may barely feel a feeling of irritation and it is possible to prevent injury from occurring in the tongue or the oral cavity since a diameter of a wire is small enough for the user to barely feel with the tongue and the fixer is provided in a round shape.

Also, according to example embodiments, it is possible to perform both the entire orthodontic treatment and partial orthodontic treatment of teeth, to provide a wire on the rear surface of teeth as well as the front surface of the teeth, thereby enhancing the readability of mounting and an aesthetic sense.

Also, according to example embodiments, it is possible to form a clearance gap between a wire and a fixer by fixing the wire that includes a detachable clearance gap former on the surface of teeth using the fixer, such as resin and by removing the clearance gap former through a simple process, thereby achieving a movement of the wire relative to resin and enabling accurate and smooth orthodontic treatment.

Also, according to example embodiments, it is possible to easily form a clearance gap since a clearance gap former is provided in a simply separable vinyl sheath type and to further efficiently perform an orthodontic process without performing an additional operation such as a cleaning operation.

Also, according to example embodiments, it is possible to enhance the reliability of orthodontic treatment by accurately positioning a position of a wire using a wire positioning unit before fixing the wire using a fixer.

### BRIEF DESCRIPTION OF DRAWINGS

FIG. 1 illustrates a state in which an orthodontic device according to an example embodiment is provided to front teeth.

FIG. 2 sequentially illustrates a mounting process of the orthodontic device of FIG. 1.

FIGS. 3a through 3f sequentially illustrate a mounting process of an orthodontic device.

FIG. 4 illustrates an example of actually applying an orthodontic device according to an example embodiment.

FIG. 5 illustrates a state in which an orthodontic device according to a second example embodiment is provided to anterior teeth.

FIG. 6 illustrates a state in which a wire is provided to the teeth of FIG. 5 and a fixer is provided.

FIG. 7 is an enlarged view of FIG. 6.

FIG. 8 illustrates a state in which a clearance gap former is removed from the wire of FIG. 7.

FIG. 9 sequentially illustrates an orthodontic method of the orthodontic device according to the second example embodiment.

FIG. 10 illustrates a partial mounting state of an orthodontic device according to a third example embodiment.

FIG. 11 illustrates an orthodontic device according to a fourth example embodiment.

FIG. 12 illustrates a state in which a wire positioning unit for positioning a wire is provided during a process of installing the wire in FIG. 11.

FIG. 13 is a cross-sectional view of a state in which a wire fixing unit is provided to teeth in FIG. 12.

FIG. 14 is a perspective view of the wire positioning unit of FIG. 12.

FIGS. 15a through 15c sequentially illustrate an orthodontic method according to an example embodiment.

### DETAILED DESCRIPTION

Hereinafter, a configuration and an application according to example embodiments are described with reference to the accompanying drawings. The following description is one of various aspects of the example embodiments and a portion of detailed description of the example embodiments.

Here, a detailed description related to a known function and configuration in describing the example embodiments is omitted for clarity of description.

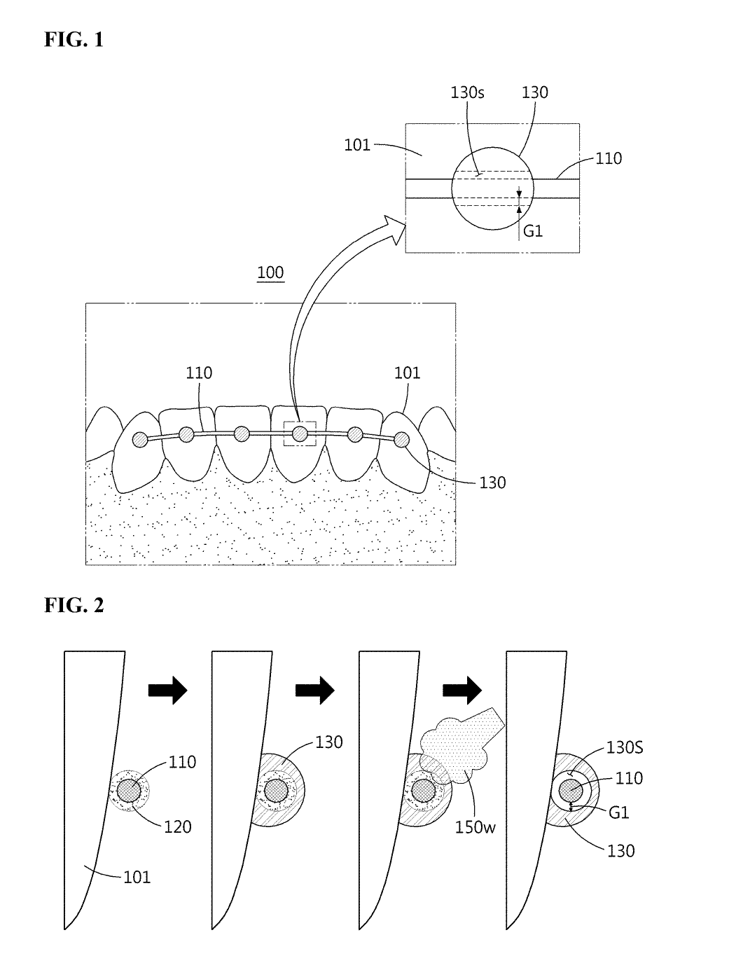

FIG. 1 illustrates a state in which an orthodontic device according to an example embodiment and FIG. 2 sequentially illustrates a mounting process of the orthodontic device of FIG. 1.

Referring to FIGS. 1 and 2, an orthodontic device 100 may include a wire 110 for orthodontic treatment of teeth 101, a coating agent 120 (see FIG. 2) that coats an outer surface of the wire 110, and a fixer 130, that is, resin 130 of the example embodiment, configured to fix the wire 110 coated with the coating agent 120 on a surface of the teeth 101 and to fix the wire 110 to be movable in a lengthwise direction of the wire 110.

Here, the fixer 130 may have flowability and be hardened over time, and may be provided as the resin 130. However, it is provided as an example only. Any type of materials having the flowability and hardened over time and harmless to the human body may be applicable as the fixer 130. Hereinafter, the fixer 130 is referred to as the resin 130.

Through this configuration, once the resin 130 is applied, the coating agent 120 is removed from the wire 110 and a clearance gap G1 is formed between the resin 130 and the wire 110. The wire 110 may be movable relative to the resin 130 in a lengthwise direction of the wire 110. Through this, the orthodontic treatment of the teeth 101 may be performed.

Hereinafter, each configuration is described. Referring to FIG. 1, the wire 110 of the example embodiment passes through the resin 130 that is fixed on the surface of the teeth 101 and thereby couples with the resin 130. The orthodontic treatment of the teeth 101 may be performed by appropriately adjusting force between the teeth 101 to which the resin 130 is provided.

The wire 110 may have various diameters. In the example embodiment, the wire 110 may have a diameter of 0.007 to 0.022 inches, desirably, 0.008 to 0.012 inches. Compared to a general diameter of the wire 110 according to the related art, the wire 110 according to the example embodiment may have a relatively small diameter, however, may transfer a proper force to the teeth 101. In addition, due to the relatively small diameter, the wire 110 may minimize a sense of irritation. It is provided as an example, and a diameter and a shape of the wire 110 are not limited thereto. Although not illustrated, the wire 110 may be configured to have, for example, a square cross-section or a rectangular cross-section.

The wire 110 may be manufactured as a shape memory alloy to store a shape of the wire 101 based on a shape of the teeth 101 corresponding to an orthodontic target. For example, Ni—Ti alloy, etc., which is harmless to the human body, may be applicable. Accordingly, once the orthodontic device 100 is provided to the teeth 101, the wire 110 is transformed to a stored shape and thus, the orthodontic treatment of the teeth 101 may be performed.

Here, to transform the wire 110 to the stored shape, the wire 110 needs to be movable relative to the resin 130.

To this end, the wire 110 is coated with the coating agent 120 and the coated wire 110 is fixed on the surface of the teeth 101 by the resin 130.

Referring to FIG. 2, the wire 110 coated with the coating agent 120 is positioned on the surface of the teeth 101 and the wire 110 coated with the coating agent 120 is fixed on the surface of the teeth 101 using the resin 130 having flowability. Here, the resin 130 is hardened on the surface of the teeth 101 and maintains a shape of the teeth 101.

Here, since the resin 130 is hardened with the wire 110 coated with the coating agent 120 being surrounded by the resin 130, the wire 130 may be fixed relative to the resin 130 and may be immovable relative to the resin 130.

However, the coating agent 120 herein is used to form the clearance gap G1 between the resin 130 and the wire 110. Thus, once the resin 130 is applied and hardened, the coating agent 120 is removed. That is, the coating agent 120 is removed from the surface of the wire 110. Accordingly, a slot 130s through which the wire 110 passes is formed on the resin 130. The wire 110 has a diameter less than an inner diameter of the slot 130s of the resin 130. Accordingly, the wire 110 may be movable relative to the resin 130 and the orthodontic treatment of the teeth 101 may be performed.

As described above, the coating agent 120 is removed from the wire 110. Although the wire 110 maintains a state in which the coating agent 120 is applied before the wire 110 is covered with the resin 130, the coating agent 120 is removed from the wire 110 after the wire 130 is covered with the resin 130.

To this end, the coating agent 120 may use a material that melts in an intraoral temperature. That is, once the wire 110 is provided in the oral cavity and the resin 130 is provided using a material that does not melt in a room temperature and slowly melts in the intraoral temperature, the coating agent 120 may be naturally and slowly removed from the wire 110.

Alternatively, the coating agent 120 may be a material that melts once it contacts with the saliva. Once the saliva contacts, the coating agent 120, as a material that interacts with the saliva, may be melted and be removed from the wire 110.

Alternatively, the coating agent 120 may be water-soluble. Referring to FIG. 2, by covering the wire 110 coated with the coating agent 120 with the resin 130 and by providing a liquid, such as water, to the coating agent 120, the coating agent 120 may melt. In this manner, the coating agent 120 may be removed from the wire 110.

The aforementioned coating agent 120 is manufactured using a material that is harmless to the human body. The coating agent 120 removed from the wire 110 remains in the oral cavity. Here, since the coating agent 120 is manufactured using the harmless material, it does not affect the human body.

The coating agent 120 may be a material, for example, caramel. A liquid is prepared by melting caramel and the prepared liquid coats the wire 110. As shown in a first image of FIG. 2 on the left, the wire 110 coated with the coating agent 120 is positioned on the surface of the teeth 101 and surrounds the wire 110 using the resin 130. Caramel is a material that melts when it contacts with the saliva. Accordingly, cameral may be melted and removed from the wire 110. The wire 110 may be movable relative to the resin 130. It is provided as an example only. A material of the coating agent 120 is not limited thereto. For example, the coating agent 120 may be a material that contains sugars or sugar-alcohol.

Meanwhile, a mobility of the wire 110 relative to the resin 130 may be adjusted based on a coating thickness of the coating agent 120. If the coating agent 120 relatively thickly coats the wire 110, the clearance gap G1 between the wire 110 and the resin 130 corresponding to a thickness of the coating agent 120 being removed may be formed. Thus, a relatively great mobility level of the wire 110 may occur relative to the resin 130. On the contrary, if the coating agent 120 relatively thinly coats the wire 110, the clearance gap G1 between the wire 110 and the resin 130 corresponding to a thickness of the coating agent 120 being removed may be formed. Here, the clearance gap may be less than the aforementioned clearance gap. Thus, a relatively small mobility level of the wire 110 may occur relative to the resin 130. The mobility of the wire 110 relative to the resin 130 may be adjusted based on a diameter or a width of the wire 110. That is, the mobility of the wire 120 relative to the resin 130 may be adjusted by adjusting the thickness of the coating agent 120 that coats the wire 110 or a size of the wire 110.

As described above, the resin 130 herein is hardened on the surface of the teeth 101 and movably fixes the wire 110. The resin 130 is provided using synthetic resin having flowability. As shown in a second image of FIG. 2 on the left, the resin 130 is applied on the surface of the teeth 101 in a round shape to surround the wire 110 and hardened on the surface of the teeth 101. The resin 130 may be hardened on the surface of the teeth 101 by photo-polymerization over a few seconds.

As described above, the resin 130 is in a curved-surface shape. A material and a shape different from a bracket of a metal material used in the related art may be used. Due to the shape of the resin 130, it may be possible to prevent injury from occurring in the tongue or another portion of the oral cavity even with a contact with the resin 130.

In addition, the resin 130 having flowability is dropped on the surface of the teeth 101 and thereby mounted on the surface of the teeth 101. That is, the mounting process is very simple. When providing the bracket on the surface of the teeth 101, it may cause pain. However, in the example embodiment, since the mounting process of the resin 130 is very simple, it is possible to minimize the occurrence of pain.

Once the resin 130 is applied on the surface of the teeth 101, a cleaning solution 150w, for example, water is sprayed to clean the resin 130 and the wire 110 as shown in a third image of FIG. 2 on the left. A mounting state as shown in a fourth image of FIG. 2 on the left may be acquired by melting the coating agent 120 using the aforementioned various schemes.

Meanwhile, the orthodontic device 100 according to the example embodiment may be applied to the entire orthodontic treatment of the teeth 101 and may be applied to the partial orthodontic treatment of the teeth 101 as shown in FIG. 1.

Referring to FIG. 1, both ends of the wire 110 are fixed to both lower dog teeth by the resin 130 and the wire 110 is provided to the lower front teeth, thereby capable of uniformly aligning the lower front teeth in an orthodontic manner.

In addition, although not illustrated, the orthodontic device 100 may be provided at the rear of the teeth 101, not at the front of the teeth 101. Since the wire 110 has a relatively small diameter and is easily attachable, the wire 110 may be easily provided at front of the teeth 101 and the rear of the teeth 101. In particular, when the orthodontic device 100 is provided at the rear of the teeth 101, the orthodontic device 100 may not be externally exposed. Thus, it is possible to enhance an aesthetic sense. In addition, since the diameter of the wire 110 is relative small and the resin 130 is also small and in a curved-surface shape, it is possible to minimize a feeling of irritation and to reduce inconvenience of a user of the orthodontic device 100.

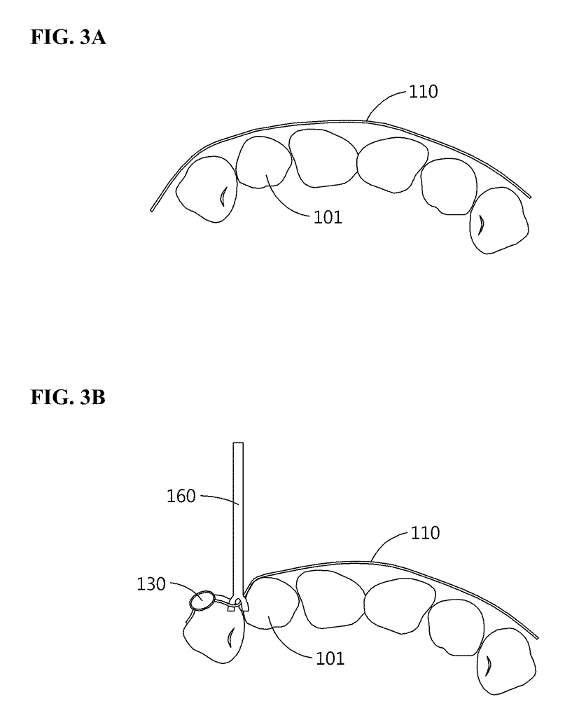

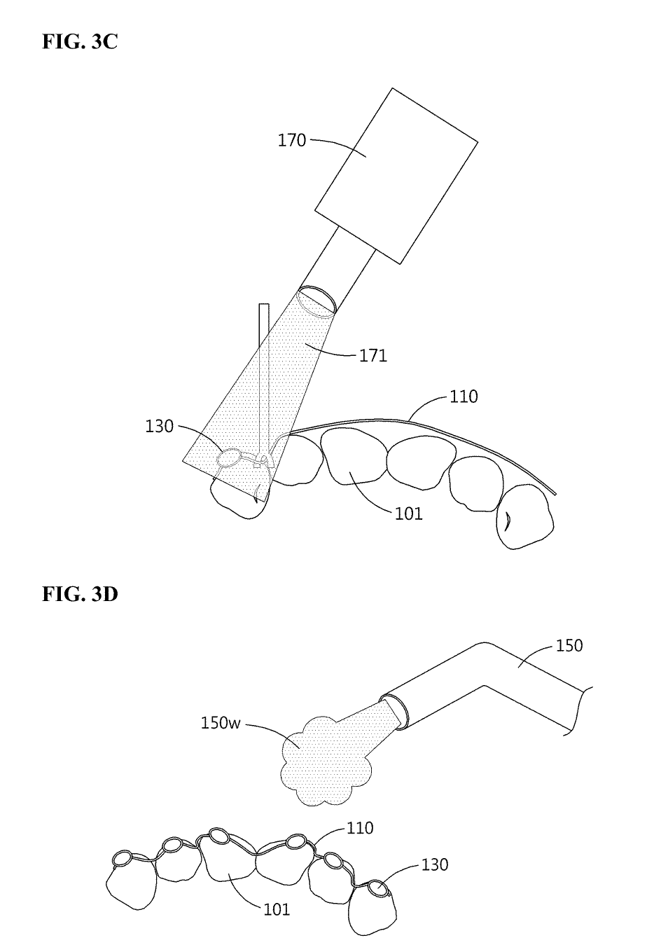

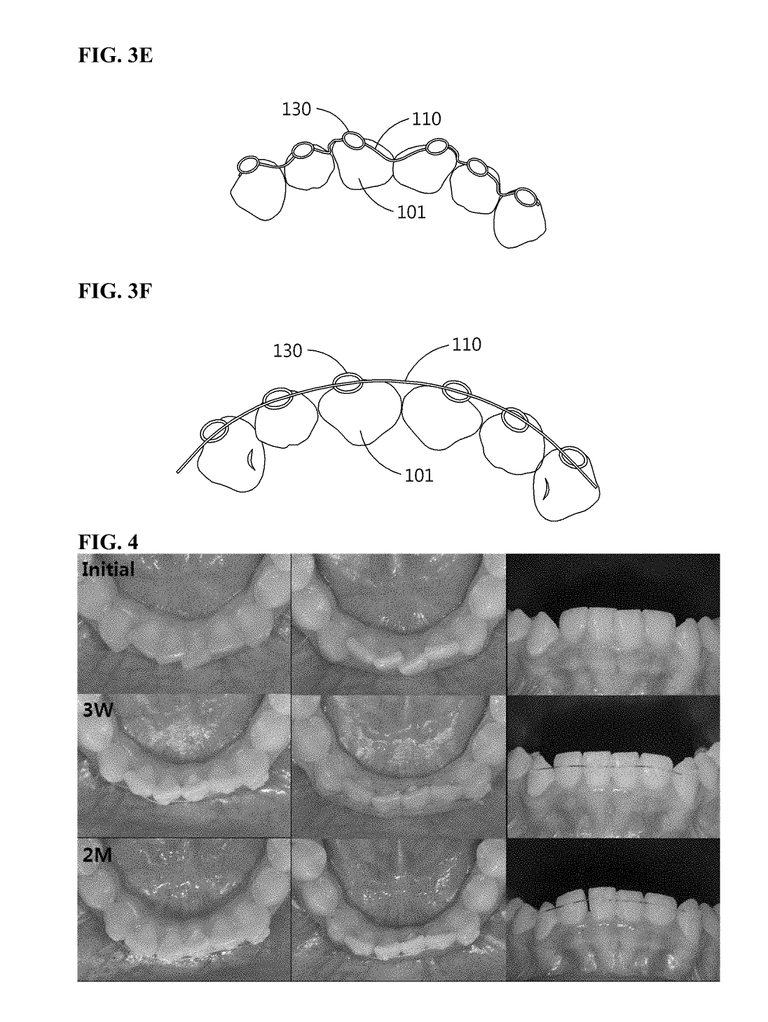

Hereinafter, an orthodontic method of the orthodontic device 100 constructed as above is described with reference to FIGS. 3A through 3F.

Referring to FIGS. 3A through 3F, the orthodontic method of the orthodontic device 100 may include positioning the wire 110 coated with the coating agent 120 on the surface of the teeth 101, fixing the wire 110 coated with the coating agent 120 on the surface of the teeth 101 using the resin 130 having flowability, and forming the clearance gap G1 between the wire 110 and the resin 130 by removing the coating agent 120 from the wire 110. Here, due to the clearance gap G1 formed in the operation of forming the clearance gap G1, the wire 110 may be movable relative to the resin 130 and the orthodontic treatment of the teeth 101 may be performed.

Referring to FIG. 3A, the wire 110 is provided, for example, at the front of the teeth 101 to approximately correspond to the shape of the teeth 101. Referring to FIG. 3B, the resin 130 having the flowability is provided on the surface of the teeth 101 to cover the wire 110 coated with the coating agent 120. Here, a wire fixer 160 may be used to fix a position of the wire 110.

Referring to FIG. 3C, light 171 is provided from a photo-polymerizer 170 and the resin 130 is fixed on the teeth 101 by photo-polymerization. If photo-polymerization of about 4 seconds is performed, the resin 130 may be firmly positioned on the surface of the teeth 101. Referring to FIG. 3D, the wire 110 and the resin 130 are provided to the teeth 101 by repeating a process of FIGS. 3B and 3C, and cleaning of the resin 130 and the wire 110 is performed by providing the cleaning solution 150w using the cleaner 150.

As a result, the orthodontic device 100 relative to the teeth 101 enters in a state of FIG. 3C. Here, as described above, the coating agent 120 may be melted using the saliva, or may be melted using heat generated due to the intraoral temperature. The coating agent 120 is removed from the wire 110, the clearance gap G1 is formed between the wire 110 and the slot 130s formed on the resin 130, and the wire 110 may be movable relative to the resin 130.

As time passes, the wire 110 prepared using the shape memory alloy may be transformed. Thus, an orthodontic force may be applied to the teeth 101 corresponding to an orthodontic target. The orthodontic treatment of the teeth 101 may be performed as shown in FIG. 3F.

FIG. 4 illustrates an example of actually applying the orthodontic device 100 according to an example embodiment.

Referring to FIG. 4, top photos show an irregular dental condition. Middle photos show the dental condition when three weeks has passed since using the orthodontic device of the example embodiment. Bottom photos show the dental condition when 2 months has passed. That is, it can be verified that the reliable orthodontic treatment is performed using the orthodontic device of the example embodiment.

According to an example embodiment, the movement of the wire 110 relative 130 may be achieved by fixing the wire 110 coated with the coating agent 120 on the surface of the teeth 101 using the resin 130 and by removing the coating agent 120. Through this, the orthodontic treatment of the teeth 101 may be smoothly performed.

In addition, since the diameter of the wire 110 is small enough to be barely felt with the tongue and the resin 130 is in a round shape, it is possible to prevent a feeling of irritation from occurring and to prevent injury from occurring in the tongue or the oral cavity.

Also, it is possible to perform both the entire orthodontic treatment and partial orthodontic treatment of the teeth 101, to provide the wire 110 on the rear surface of the teeth 101 as well as on the front surface of the teeth 101, thereby enhancing the readability of mounting and an aesthetic sense.

Hereinafter, an orthodontic device according to a second example embodiment is described.

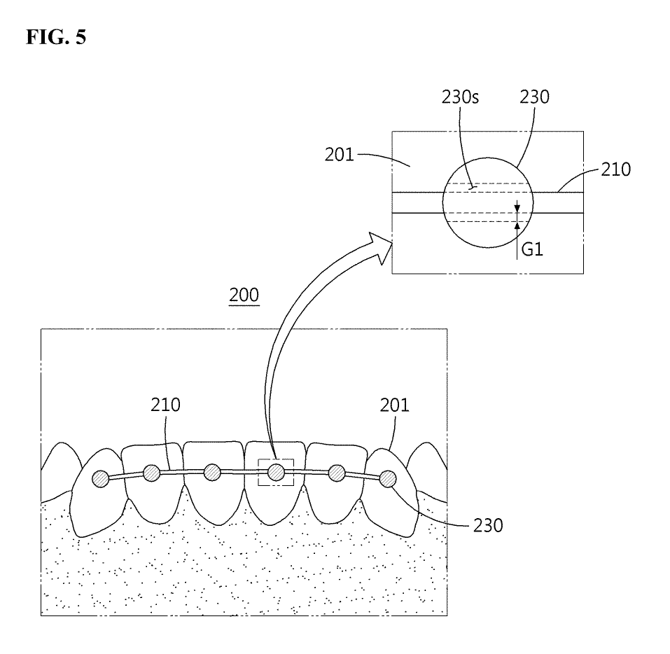

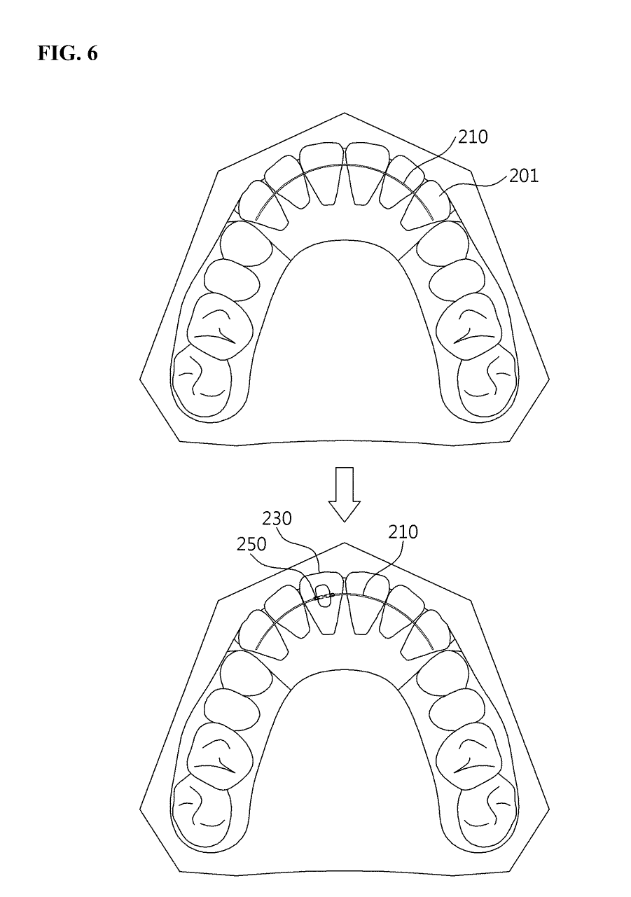

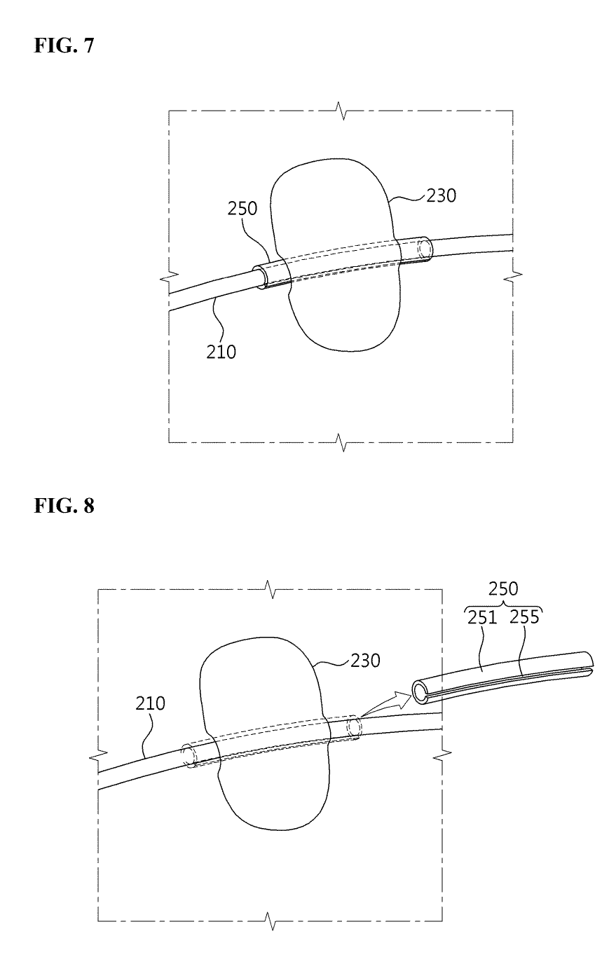

FIG. 5 illustrates a state in which the orthodontic device according to the second example embodiment is provided to anterior teeth, FIG. 6 illustrates a state in which a wire is provided to the teeth of FIG. 5 and a fixer is provided, FIG. 7 is an enlarged view of FIG. 6, and FIG. 8 illustrates a state in which a clearance gap former is removed from the wire of FIG. 7.

Referring to FIGS. 5 through 8, an orthodontic device 200 according to the second example embodiment may include a wire 210 for orthodontic treatment of teeth 201, a clearance gap former 250 detachably provided to the wire 210, and a fixer 230, that is, resin 230 of the example embodiment, configured to fix the wire 210 that includes the clearance gap former 250 on the surface of the teeth 201 and to fix the wire 210 to be movable along a lengthwise direction of the wire 210.

Through the above configuration, the wire 210 may be movably fixed using the resin 230 instead of using a bracket. Thus, compared to the related art, a mounting process of the orthodontic device 200 may be simple and it is possible to reduce the occurrence of pain. In addition, compared to the related art, the wire 210 is thin and the resin 230 is in a round shape. Thus, it is possible to minimize the occurrence of a feeling of irritation and to prevent injury from occurring due to interference between the tongue or an inner portion of lips and a corner portion of the bracket.

To this end, the orthodontic device 200 further includes the clearance gap former 250 configured to form a clearance gap between the wire 210 and the resin 230.

Referring to FIGS. 6 through 9, the clearance gap former 250 detachably couples with the wire 210 to partially surround a portion of the outer surface of the wire 210. That is, instead of providing the clearance gap former 250 over the entire wire 210, the clearance gap former 250 is provided to one area of the wire 210 to which the resin 230 is supplied.

The clearance gap former 250 includes an inner diameter corresponding to a diameter of the wire 210 and has an overall elongated hollow shape. Since a separable portion 255 (see FIG. 8) is provided to one side of the clearance gap former 250, the clearance gap former 250 may easily couple with the wire 210 and may easily separate from the wire 210.

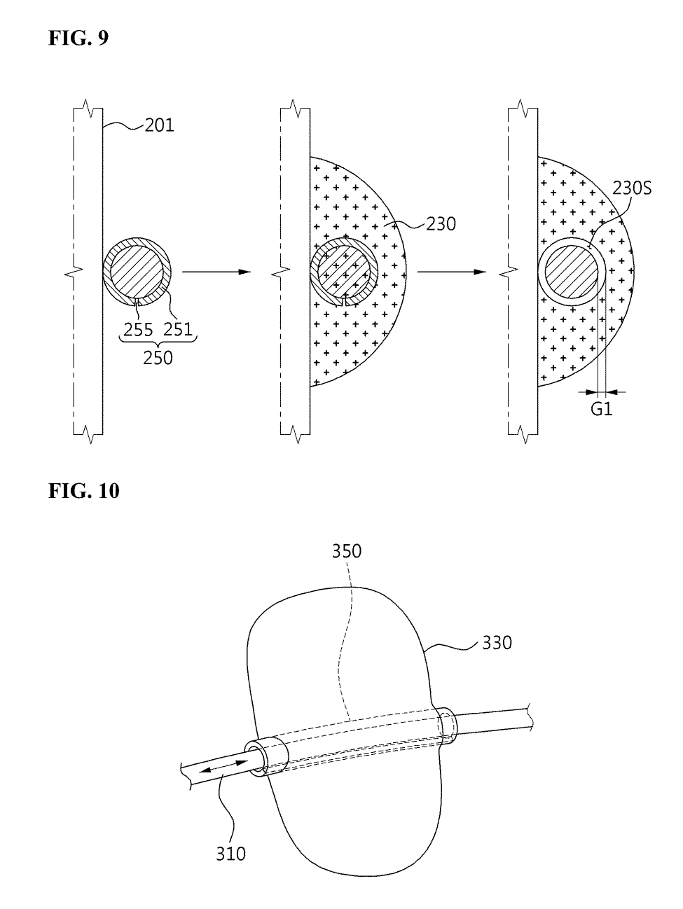

In detail, referring to FIGS. 7 and 8, the clearance gap former 250 may include a clearance gap forming body 251 having an inner diameter or an inner width corresponding to the diameter or a width of the wire 210 and having a thickness corresponding to a size of the clearance gap G1 (see FIGS. 5 and 9) to be formed and the separable portion 255, that is, the slit 255 of the example embodiment, formed on one side of the clearance gap forming body 251 along a lengthwise direction of the clearance gap forming body 251.

The clearance gap forming body 251 has an inner diameter corresponding to a shape of the wire 210, for example, has a flexible pipe shape. The elongated slit 255 is formed on the clearance gap forming body 251. Accordingly, it is possible to easily provide the clearance gap former 250 to the wire 210 by spreading the slit 255 and then coupling the clearance gap forming body 251 and the wire 210.

In addition, when removing the clearance gap former 250 from the wire 210, it is possible to grip and pull one end of the clearance gap forming body 251 with a grip device such as tweezers, etc. In this case, the clearance gap former 250 may be separated from the wire 210 as the slit 255 of the clearance gap forming body 251 is spread.

The clearance gap former 250 may be provided as a vinyl sheath using a material that is harmless to the human body and does not chemically react to the wire 210, the resin 230, etc., and that does not react to the saliva, water-soluble, etc. Also, the clearance gap former 250 has an elastic force. Accordingly, the elastic clearance gap former 250 may be provided by combining the material used to form the vinyl sheath and the elastic material. Since the clearance gap former 250 has the elastic force, the slit 255 may readily spread and restore to an original state and the clearance gap forming body 251 may also readily bend and restore to an original state. Accordingly, a mounting and separating process of the clearance gap former 250 relative to the wire 210 may be easily performed.

Since the clearance gap former 250 may be manufactured at low cost, it is possible to significantly reduce cost used for orthodontic treatment.

Since the mobility of the wire 210 relative to the resin 230 is adjusted based on a clearance gap level between the outer surface of the wire 210 and the inner surface of the resin 230, a thickness of the clearance gap forming body 251 of the clearance gap former 250 may be manufactured to fit according thereto.

For example, if the clearance gap former 250 that includes the clearance gap forming body 251 having a relatively thick thickness is provided to the wire 210 and the clearance gap former 250 is removed from the wire 210, a clearance gap between the wire 210 and the resin 230 corresponding to the relatively thick thickness of the clearance gap forming body 251 may be formed. Thus, a mobility level of the wire 210 relative to the resin 230 may be relatively great. On the contrary, if the clearance gap former 250 that includes the clearance gap forming body 251 having a relatively thin thickness is provided to the wire 210 and the clearance gap former 250 is removed from the wire 210, a clearance gap corresponding to the relatively thin thickness of the clearance gap forming body 251 may be formed. Thus, a mobility level of the wire 210 relative to the resin 230 may be relatively small. In addition, the mobility of the wire 210 relative to the resin 230 may be adjusted based on the diameter or the width of the wire 210.

That is, the mobility of the wire 210 relative to the resin 230 may be optimized by adjusting the thickness of the clearance gap former 250 that is detachably provided to the wire 210 or by adjusting the diameter or the width of the wire 210.

Referring to FIGS. 7 and 8, the resin 230 covers the clearance gap former 250 to expose both ends or at least one end of the clearance gap forming body 251 of the clearance gap former 250 from the resin 230. Accordingly, the clearance gap former 250 may be separated from the wire 210 by gripping and pulling an exposed portion of the clearance gap forming body 251 with a grip device, for example, tweezers and the like.

Here, although not illustrated, a member to be gripped by the grip device may be provided to at least one end of both ends of the clearance gap forming body 251 to further easily and accurately grip the exposed portion of the clearance gap forming body 251. The member to be gripped may protrude from the outer surface of the clearance gap forming body 251 and may be in a hook shape, which may facilitate gripping by the grip device. However, it is provided as an example only.

The clearance gap former 250 may use a shaping-enabling material that may be transformable to a set shape. That is, an operator may set the clearance gap between the wire 210 and the resin 230 and may manufacture the clearance gap former 250 to be shaping-enabling based on the set clearance gap. The separable portion 55 may be provided even to the clearance gap former 250 constructed as above and the clearance gap former 250 may be easily removed from the wire 210.

Meanwhile, although the separable portion 255 provided to the clearance gap former 250 may be provided as the slit 255, it is provided as an example only. The separable portion may be provided in a dotted-line shape of the clearance gap forming body 251. The clearance gap former 250 having the separable portion in the above shape may be inserted at the end of the wire 210. If the clearance gap former 250 is pulled using the grip device, such as tweezers and the like, for removal, the dotted line may be spread, thereby separating the clearance gap former 250 from the wire 210.

Hereinafter, an orthodontic method of the orthodontic device 200 according to the second example embodiment constructed as above is described with reference to FIG. 9.

FIG. 9 sequentially illustrates the orthodontic method of the orthodontic device according to the second example embodiment.

Referring to FIG. 9, the orthodontic method of the orthodontic device 200 may include positioning the wire 210 detachably coupled with the clearance gap former 250 on the surface of the teeth 201, fixing the wire 210 coupled with the clearance gap former 250 on the surface of the teeth 201 using the resin 230, and forming a clearance gap between the wire 210 and the resin 230 by separating the clearance gap former 250 from the wire 210.

The wire 210 that includes the clearance gap former 250 is provided to the teeth 201 as shown in a leftmost image of FIG. 9, and the resin 230 having the flowability is provided on the surface of the teeth 201 to cover the wire 210 that includes the clearance gap former 250 as shown in a middle image of FIG. 9. Here, although not illustrated, a fixer for fixing a position of the wire 210 may be used.

Although not illustrated, the resin 230 may be fixed on the surface of the teeth 201 through photo-polymerization by providing light from a photo-polymerizer.

As shown in a rightmost image of FIG. 9, once the clearance gap former 250 provided to the wire 210 is pulled using a grip device (not shown), such as tweezers, etc., the slit 255 of the elastic clearance gap forming body 251 is spread and the clearance gap former 250 may be removed from the wire 210. The clearance gap G1 may be formed between the wire 210 and a slot 230S formed on the resin 230, which enables the movement of the wire 210 relative to the resin 230.

As time passes, the wire 210 prepared using a shape memory alloy may be transformed. Thus, an orthodontic force may be applied to the teeth 201 corresponding to an orthodontic target. The orthodontic treatment of the teeth 201 may be performed.

According to the second example embodiment, the clearance gap may be formed between the wire 210 and the resin 230 by fixing the wire 210 to which the clearance gap former 250 is detachably provided on the surface of the teeth 201 using the resin 230 and by removing the clearance gap former 250 through a simple process. Through this, the movement of the wire 210 relative to the resin 230 may be achieved. Thus, the orthodontic treatment of the teeth 201 may be smoothly performed.

Here, the clearance gap former 250 may be provided in a simply separable vinyl sheath type. Thus, it is possible to easily form the clearance gap. In addition, although an additional operation, such as a cleaning operation, is not performed, it is possible to further efficiently perform an orthodontic process of the teeth 201.

In addition, since the diameter of the wire 210 is small enough to be barely felt with the tongue and the resin 230 is in a round shape, it is possible to prevent a feeling of irritation from occurring and to prevent injury from occurring in the tongue or the oral cavity.

Also, it is possible to perform both the entire orthodontic treatment and partial orthodontic treatment of the teeth 201, to provide the wire 110 on the rear surface of the teeth 201 as well as on the front surface of the teeth 201, thereby enhancing the readability of mounting and an aesthetic sense.

Meanwhile, although an example of providing a single wire 210 to a set of teeth is described with reference to the second example embodiment, the mounting process of the resin 230 is simple, a thickness of the wire 210 is thin, and the wire 210 is selectively applicable. For example, two wires 210 may be provided to a set of teeth to be in parallel and the orthodontic treatment of the teeth 201 may be performed using a different alignment structure.

Hereinafter, a configuration of an orthodontic device according to a third example embodiment is described. Herein, a description related to a substantially same portion as the aforementioned orthodontic device is omitted.

FIG. 10 illustrates a partial mounting state of the orthodontic device according to the third example embodiment

Referring to FIG. 10, the orthodontic device according to the third example embodiment may include a wire 310, a sheath 350 configured to couple with the wire 310 to surround a portion of the outer surface of the wire 310 and to be movable in a lengthwise direction of the wire 310, and a fixer 330, that is, resin 330 of the example embodiment, configured to fix on the surface of teeth to cover the wire 310 that includes the sheath 350.

Here, once the sheath 350 is covered with the resin 330, the sheath 350 may be attached to the resin 330 through mutual reaction between the resin 330 and the sheath 350. That is, the sheath 350 may be closely attached to the resin 330 and may be integrated with the resin 330.

To this end, the sheath 350 may use a material capable of chemically reacting to and integrating with the resin 330, and may use a material that does not react to the wire 310 and thereby, enables a movement of the wire 210 relative to the sheath 350.

The clearance gap former 250 (see FIG. 7) of the second example embodiment does not mutually react with the resin 230 and the wire 210 and thus, is provided as the removable vinyl sheath 250. On the contrary, the sheath 350 of the third example embodiment may be manufactured using a material that integrates with the resin 330 in reaction thereto and does not react to the wire 310.

In addition, referring to FIG. 10, an inner diameter of the sheath 350 is slightly greater than an outer diameter of the wire 310 so that the wire 310 may be smoothly movable relative to the sheath 350 integrated with the resin 330. For example, if the diameter of the wire 310 is 0.08 inches, the diameter of the sheath 350 may be about 0.12 inches, which is slightly greater than the diameter of the wire 310, and here, the clearance gap may be formed between the wire 310 and the sheath 350. Accordingly, the wire 310 may be movable relative to the resin 330 with which the sheath 350 is integrated.

However, it is provided as an example only. A method of providing an attachment portion or a material for attachment, which is harmless to the human body, between the sheath 350 and the resin 350 and attaching the sheath 350 to the resin 330 may be applied.

As described above, according to the third example embodiment, since the wire 310 may be readily movable relative to the sheath 350, the orthodontic treatment of teeth may be smoothly and accurately performed.

Hereinafter, an orthodontic device according to a fourth example embodiment is described.

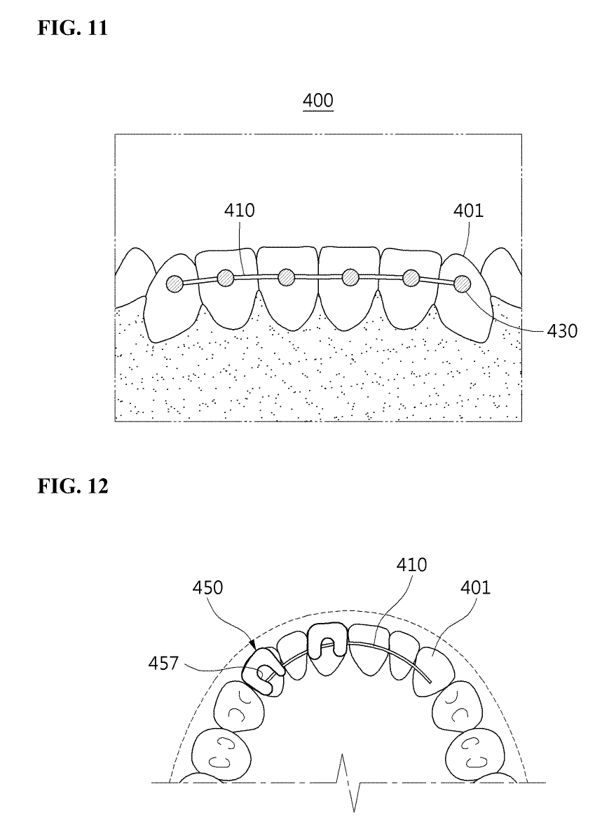

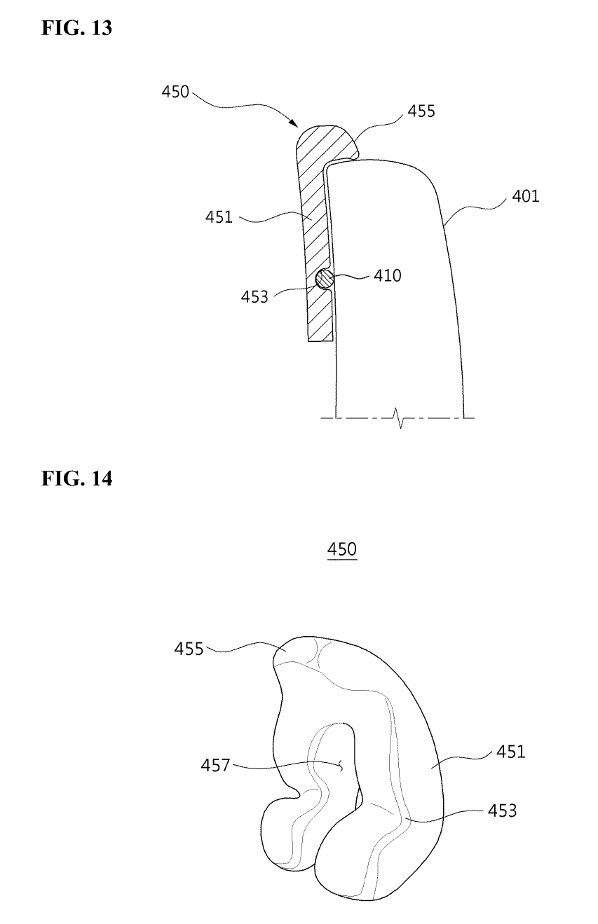

FIG. 11 illustrates an orthodontic device according to a fourth example embodiment, FIG. 12 illustrates a state in which a wire positioning unit for positioning a wire is provided during a process of installing the wire in FIG. 11, FIG. 13 is a cross-sectional view of a state in which a wire fixing unit is provided to teeth in FIG. 12, and FIG. 14 is a perspective view of the wire positioning unit of FIG. 12.

Referring to FIG. 11, an orthodontic device 400 according to the fourth example embodiment may include a wire 410 for orthodontic treatment of teeth, a fixer 430, that is, resin 430 of the example embodiment, configured to fix the wire 410 on the surface of teeth 401 to be movable in a lengthwise direction of the wire 410, and a wire positioning unit 450 provided to the teeth 401 before fixing the wire 410 on the surface of the teeth 401 using the fixer 430 and configured to position the wire 410 relative to the teeth 401.

Through this configuration, it is possible to accurately position and then fix the wire 410 relative to the teeth 401 corresponding to an orthodontic target. Thus, it is possible to enhance the accuracy of the orthodontic treatment of the teeth 401.

As described above, the wire 410 needs to be movable in a lengthwise direction of the wire 410 while maintaining a position of the wire 410 relative to the resin 430. To this end, a clearance gap needs to be formed between the outer surface of the wire 410 and the inner surface of the resin 430 that surrounds the wire 410.

A variety of methods may be applied. For example, the wire 410 may be movable relative to the resin 430 by coating the wire 410 with a removable coating agent (not shown), by surrounding the wire 410 coated with the coating agent using the resin 430, and by removing the coating agent from the wire 410. However, it is provided as an example only. Any type of structures capable of movably fixing the wire 410 relative to the resin 430 may be applied.

Meanwhile, in terms of the orthodontic treatment of the teeth 401, it may be most important to accurately position the position of the wire 410 for orthodontic treatment of the teeth 401 and then fix the wire 410 using the resin 430. That is, accurately positioning the wire 410 needs to be performed before fixing the wire 410 using the resin 430.

To this end, referring to FIGS. 12 and 13, the orthodontic device 400 includes the wire positioning unit 450 configured to accurately provide the wire 410 at an accurate position before fixing the wire 410 using the resin 430.

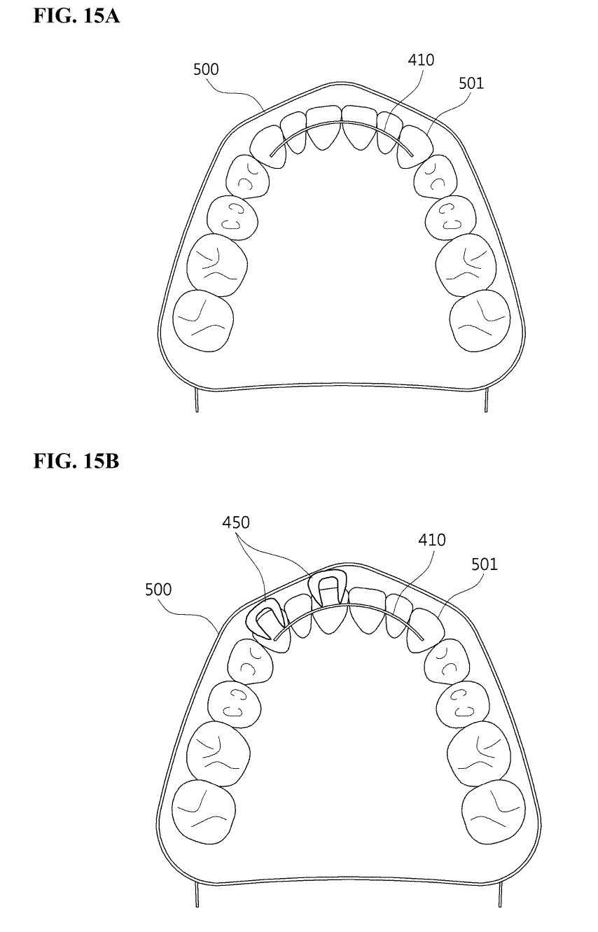

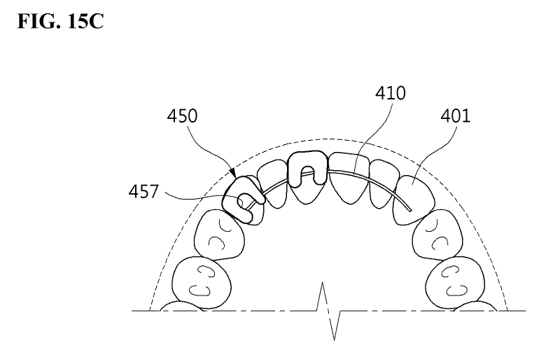

That is, for the orthodontic treatment of the teeth 401, a casting mold 500 (see FIG. 15A) is prepared based on a shape of the teeth 401 corresponding to an orthodontic target. The wire positioning units 450 are manufactured to fit model teeth 501 of the casting mold 500. Positioning of the wire 410 may be performed by separating the wire 410 and the wire positioning units 450 from the casting mold 500 and by providing the wire 410 to the teeth 401 of a corresponding user.

Describing a configuration of the wire positioning unit 450 in detail with reference to FIGS. 12 through 14, the wire positioning unit 450 may include a body 451 configured to form a basic frame, a slot 453 recessed from the inner surface of the body 451 that faces the surface of the teeth 401 and to position the wire 410 in such a manner that the wire 410 provided on the surface of the teeth 401 is inserted into the slot 453, and a protrusion 455 provided to the body 451 so that the body 451 is detachably attached to the teeth 401.

Through this configuration, as shown in FIGS. 12 and 13, the wire positioning units 450 may be provided to an upper portion of the teeth 401 and the wire 410 may pass between the slots 453 formed on the bodies 451, thereby positioning the position of the wire 410. Accordingly, a fixing operation of the wire 410 may be performed using the fixer 430 after positioning the wire 410 at an accurate position.

In the example embodiment, the body 451 may be provided to cover the surface of the tooth 401, that is, a portion of the outer surface and the inner surface of the tooth 401 and a portion of an upper portion of the tooth 401 based on FIG. 13. Referring to FIG. 3, the body 451 may be provided in a shape similar to a reverse L. Here, the wire positioning unit 450 may be easily stopped by the tooth 401 and a position of the wire positioning unit 450 may be maintained by providing an upper end of the body 451 using the protrusion 455.

Referring to FIGS. 12 and 13, the slot 453 according to the example embodiment is formed in a direction corresponding to the lengthwise direction of the wire 410. The slot 453 may be recessed from the inner surface of the body 451 that faces the surface of the tooth 401. If a cross-section of the wire 410 is in a round shape, a recessed shape of the slot 453 may be provided in a round shape corresponding thereto. For example, if the cross-section of the wire 410 is in a rectangular shape, the recessed shape of the slot 453 may be provided in a shape corresponding thereto.

An inner diameter or width of the slot 453 may be formed with a size corresponding to a largest wire 410 among the applicable wires 410. In the above example, the wire 410 may have a diameter or a width of, for example, 0.007 to 0.022 inches. In this case, the slot 453 may be formed with a size of the wire 410 of 0.022 inches.

Meanwhile, as described above, an operation of fixing the wire 410 using the fixer 430 in a state in which the wire 410 is positioned using the wire positioning unit 450 may be performed. To this end, a mounting hole 457 is formed on a central portion of the body 451 of the wire positioning unit 450.

Referring to FIGS. 12 through 14, the mounting hole 457 formed on the body 451 is recessed inward from an opposite site of the protrusion 455. The body 451 is in an overall U shape, for example, a reverse U shape based on FIG. 2. Due to this shape, the wire 410 is exposed through the mounting hole 457 of the body 451. An operation of fixing the wire 410 relative to the resin 430 may be performed by covering the wire 410 exposed through the mounting hole 457 with the resin 430.

As described above, since the operation of fixing the wire 410 relative to the resin 430 is performed after positioning the wire 410 at an accurate position using the wire positioning unit 450, the reliability for orthodontic treatment of the teeth 401 may be enhanced.

FIGS. 15A through 15C sequentially illustrate an orthodontic method according to the example embodiment.

Referring to FIGS. 15A through 15C, the orthodontic method of the orthodontic device 400 may include a wire position setting operation, a mounting operation, a wire fixing operation, and a unit separating operation of separating the wire positioning unit 450.

Hereinafter, each operation is described. Referring to FIGS. 15A and 15B, the wire position setting operation may be an operation of positioning the wire 410 for orthodontic treatment on the casting mold 500 that is acquired from a bone of the teeth 401 corresponding to an orthodontic target and providing the wire positioning unit 450 manufactured to fit the mold teeth 501 to model teeth 501 of the casting mold 500. Through this, a position of the wire 410 may be accurately set before providing the wire 410 to the actual teeth 401.

Referring to FIG. 15C, the mounting operation may be an operation of separating the wire positioning unit 450 and the wire 410 from the casting mold 500, positioning the wire 410 on the teeth 401 corresponding to the actual orthodontic target, and providing the wire positioning unit 450. As described above, since the wire positioning unit 450 includes the slot 453, the wire 410 may be positioned in an inserted state.

The wire fixing operation may be an operation of fixing the wire 410 using the fixer 430, that is, the resin 430. Since the mounting hole 457 is formed in the body 451 of the wire positioning unit 450, the resin 430 may be provided to the wire 410 exposed through the mounting hole 451 and the wire 410 may be fixed on the surface of the teeth 401.

The unit separating operation may be an operation of separating the wire positioning unit 450 that maintains a state being hung by the teeth 401. Through this, the orthodontic state of the teeth 401 of FIG. 11 may be achieved.

The orthodontic treatment of the teeth 401 may be performed by adjusting an orthodontic force between the teeth 401 using the wire 410 provided using a memory shape alloy.

According to example embodiments, since the position of the wire 410 may be accurately positioned by the wire positioning unit 450 before fixing the wire 410 relative to the resin 430, it is possible to enhance the reliability for orthodontic treatment of the teeth 401.

In addition, since the wire 410 with a small diameter or width may be fixed using the resin 430, a feeling of irritation may barely occur. In addition, it is possible to prevent injury from occurring in the tongue or the oral cavity.

In particular, the orthodontic device 400 according to the example embodiment may be applied to many orthodontic patients of an anterior teeth portion, and may also be applied from middle aged males or females of 30s or 40s to the senior. In addition, the orthodontic device 400 does not use a bracket structure and thus, may be applied to infants, children, and teenagers having a negative perception against a bracket.

Meanwhile, the present disclosure is not limited to the example embodiments and it is apparent to those skilled in the art that various modifications and changes may be made thereto without departing from the spirit and scope of the disclosure. Accordingly, such modified example or examples may be regarded to belong to the claims of the disclosure.

1. An orthodontic device comprising:
a wire for orthodontic treatment of teeth;
a coating agent configured to coat an outer surface of the wire; and
a fixer configured to fix the wire coated with the coating agent on a surface of the teeth, and to fix the wire to be movable along a lengthwise direction of the wire,
wherein the coating agent that coats the wire is covered with the fixer and then removed from the wire and a clearance gap is formed between the fixer and the wire,
wherein the fixer is provided using resin having flowability and hardened on the surface of the teeth,
wherein the fixer is provided to the surface of the teeth so that the wire coated with the coating agent and then light is provided from photo-polymerizer to fix the fixer to the surface of the teeth by photo polymerization,
wherein the fixer is attached to the teeth and then a cleaning solution is supplied from a cleaner to clean the fixer and the wire.

2. The orthodontic device of claim 1, wherein the coating agent uses a material that melts in an intraoral temperature, a material that melts in reaction with the intraoral saliva, or a water-soluble.

3. The orthodontic device of claim 1, wherein a mobility of the wire relative to the fixer is adjusted by adjusting a size of a width or a diameter of the wire or by adjusting a coating thickness of the coating agent relative to the wire.

4. The orthodontic device of claim 1, wherein the wire is manufactured as a shape memory alloy to store a shape of the wire based on a shape of teeth corresponding to an orthodontic target.

5. The orthodontic device of claim 4, wherein a diameter of the wire is within 0.007 to 0.022 inches, or the wire has a square cross-section or a rectangular cross-section of which a diagonal length is within 0.007 to 0.022 inches.

6. The orthodontic device of claim 1, wherein the fixer is provided using resin having flowability and hardened on the surface of the teeth.

7.-12. (canceled)

13. An orthodontic device comprising:
a wire for orthodontic treatment of teeth;
a clearance gap former detachably provided to the wire to surround a portion of an outer surface of the wire; and
a fixer configured to fix the wire that includes the clearance gap former on a surface of the teeth, and to fix the wire to be movable along a lengthwise direction of the wire,
wherein the clearance gap former includes an inner diameter or an inner width corresponding to a diameter or a width of the wire, and one side of the clearance gap former is provided as a separable portion to surround the wire and to be separable from the wire, and
when the wire that includes the clearance gap former is covered with the fixer, a clearance gap is formed between the wire and the fixer by removing the clearance gap former from the wire.

14. The orthodontic device of claim 13, wherein the clearance gap former comprises a clearance gap forming body including the inner diameter corresponding to the diameter or the width of the wire and having a thickness corresponding to the clearance gap, and
the separable portion is a slit that is formed on one side of the clearance gap forming body along a lengthwise direction of the clearance gap forming body.

15. The orthodontic device of claim 13, wherein the clearance gap former is formed using an elastic vinyl sheath.

16. The orthodontic device of claim 13, wherein the clearance gap former is formed using a material that does not chemically react to the wire or the fixer.

17. The orthodontic device of claim 13, wherein, when the wire that includes the clearance gap former is covered with the fixer, the clearance gap former is formed so that at least one end of both ends of the clearance gap former is exposed from the fixer, and
the clearance gap former is removed from the wire by pulling a portion of the clearance gap former exposed from the fixer.

18. The orthodontic device of claim 17, wherein at least one end of the both ends of the clearance gap former is provided as a member to be gripped that is gripped by a grip device.

19. The orthodontic device of claim 13, wherein a mobility of the wire relative to the fixer is adjusted by adjusting a size of the diameter or the width of the wire or by adjusting a thickness of the clearance gap former that is detachably provided to the wire.

20. The orthodontic device of claim 13, wherein the fixer is provided using resin having flowability and hardened on the surface of the teeth.

21.-30. (canceled)

31. An orthodontic device comprising:
a wire for orthodontic treatment of teeth;
a fixer configured to fix the wire on a surface of the teeth, and to fix the wire to be movable along a lengthwise direction of the wire; and
a wire positioning unit provided to the teeth before fixing the wire on the surface of the teeth using the fixer and configured to position the wire relative to the teeth.

32. The orthodontic device of claim 31, wherein the wire positioning unit comprises:
a body;
a slot recessed from an inner surface of the body that faces the surface of the teeth and configured to position the wire on the surface of the teeth; and
a protrusion provided to the body so that the body is detachably hung by the teeth, and
a mounting hole through which a fixer configured to fix the wire on the surface of the teeth is provided to the wire is formed on at least a portion of a central portion of the body.

33. The orthodontic device of claim 32, wherein the mounting hole of the body is recessed inward from an opposite side of the protrusion and the body is in a U shape.

34. The orthodontic device of claim 32, wherein a diameter of the wire is within 0.007 to 0.022 inches, or the wire has a square cross-section or a rectangular cross-section of which a diagonal length is within 0.007 to 0.022 inches, and
the slot is formed with a size corresponding to a largest wire among wires applicable to the teeth.

35. The orthodontic device of claim 32, wherein the fixer is provided using resin having flowability and hardened on the surface of the teeth.

36. The orthodontic device of claim 32, further comprising:
a coating agent configured to coat the outer surface of the wire,
wherein the coating agent is covered with the fixer and then removed from the wire and a clearance gap is formed between the fixer and the wire.

37.-39. (canceled)
